(19) United States
(12) Patent Application Publication
(10) Pub. No.: US 2021/0349930 A1
(43) Pub. Date: Nov. 11, 2021

(54) METHOD AND SYSTEM FOR CUSTOMIZING A MEDIA FILE

(71) Applicant: My Channel Team, Inc., Boulder, CO (US)

(72) Inventors: Heather K. Margolis, Boulder, CO (US); Kevin Cawley, Boulder, CO (US); Brad Weber, Broomfield, CO (US)

(73) Assignee: My Channel Team, Inc., Boulder, CO (US)

(21) Appl. No.: 16/868,238

(22) Filed: May 6, 2020

(51) Int. Cl. G06F 16/41; H04L 29/08

(52) U.S. Cl. CPC G06F 16/41; H04L 67/02

(57) ABSTRACT

A first method and system for customizing a file comprising at least one of audio or video content comprises receiving a baseline file comprising at least one of audio or video content, receiving a first file, and generating a customized file comprising at least one of audio or video content comprising the first file and the baseline file comprising at least one of audio or video content. A second method and system for customizing a media file comprises receiving a first baseline media file, receiving a first customization file, generating a first customized media file comprising the baseline media file and the first customization file, determining one or more customization preferences, and customizing a second baseline media file using the one or more customization preferences to generate a customized second media file in response to a triggering event.

### TECHNICAL FIELD

The present Application is directed towards media customization, and more particularly, to customizing media files.

### BACKGROUND

A channel partner is a company that partners with a vendor, which can be a manufacturer or producer, to market and sell the vendor's products, services, or technologies. Channel partners may be distributors, retailers, consultants, system integrators, technology deployment consultancies, value-added resellers, or other such organizations.

Channel marketing is often executed through a co-branding relationship between the channel partners and the vendors. Vendors provide marketing materials specific to their own products and services, and channel partners customize those marketing materials with their own information specific to their marketing goals. Channel partners then deploy the customized marketing materials.

Because vendors have deep subject matter expertise for their products, they are generally better at creating targeted marketing for their products to end customers. Once vendors provide marketing materials to channel partners, it can be difficult to track or follow how those materials are utilized, however, or determine if end users are engaged by them. Once vendors create their own marketing materials, they are reliant on channel partners to deploy them.

Channel partners have better expertise in how to promote their own platforms and how to promote products and services within their platforms or marketplaces. Channel partners often strive for a cohesive aesthetic and experience for their own platforms or marketplaces. They also want to drive customer traffic back to their own platforms or marketplaces to purchase the vendor's products. Because channel partners often deal with many vendors, each of which may provide their marketing material, it can be expensive and time consuming for channel partners to customize each vendor's marketing materials for their platforms or marketplaces. When channel partners are not able to customize marketing materials to match their own needs, the marketing materials sometimes do not get used. This can lead to a product or service not being optimally promoted on the channel partner's platform, and lost sales for both parties.

Some vendors frequently provide new or updated marketing content to channel partners, including videos in addition to other media types, to promote their products. Channel partners do not always have the resources to customize and integrate that marketing content, however. This can also result in fewer sales, impacting both vendors and partners.

Under prior methods, when vendors provide marketing content to channel partners, that content is either downloaded and moved to a partner platform or sent to potential customers via an email. As such, there was no way for the vendor to determine how the partner may have used or customized the marketing content, or how many times the marketing content was viewed.

What is needed is an easier way for channel partners to obtain customized marketing content. What is also needed is a way for vendors to track the utilization of those marketing materials so that both vendors and channel partners can optimize their efforts to engage the end customer.

### SUMMARY

A method of automatically customizing a file comprising at least one of audio or video content is provided. The method comprises receiving a baseline file comprising at least one of audio or video content, receiving a first file comprising at least one of audio or video content, and generating a customized file comprising at least one of audio or video content comprising the first file comprising at least one of audio or video content and the baseline file comprising at least one of audio or video content.

A method of automatically customizing a media file is provided. The method comprises receiving a first baseline media file, receiving a first customization file, generating a first customized media file comprising the baseline media file and the first customization file, determining one or more customization preferences based on at least one of: the first customization file, a preset preference, or a preference determined via a user action, and customizing a second baseline media file using the one or more customization preferences to generate a customized second media file in response to a triggering event.

A system for automatically customizing a file comprising at least one of audio or video content is provided. The system comprises a media file receiving module configured to receive a baseline file comprising at least one of audio or video content, a media customizations preferences receiving module configured to receive a first file comprising at least one of audio or video content, and a media customization module configured to generate a customized file comprising at least one of audio or video content comprising the first file comprising at least one of audio or video content and the baseline file comprising at least one of audio or video content.

A system for automatically customizing media files is provided. The system comprises a media file receiving module configured to receive a first baseline media file, a media customization preferences receiving module configured to receive a customization file, a media customization module configured to generate a first customized media file comprising the baseline media file and the first customization file, a customization preferences determination module configured to determine one or more customization preferences based on at least one of: the first customization file, a preset preference, or a preference determined via a user action, and wherein the media customization module is further configured to customize a second baseline media file using the one or more customization preferences to generate a customized second media file in response to a triggering event.

### BRIEF DESCRIPTION OF THE DRAWINGS

The same reference number represents the same element on all drawings. The drawings are not necessarily to scale.

FIG. 1A depicts method 100A, in accordance with an embodiment;

FIG. 1B depicts method 100B, in accordance with an embodiment;

FIG. 2 depicts method 200, in accordance with an embodiment;

FIG. 3 depicts system 300, in accordance with an embodiment;

FIG. 4 depicts system 400, in accordance with an embodiment;

FIG. 5 depicts system 500, in accordance with an embodiment;

FIG. 6 depicts ordered set of media files 600, in accordance with an embodiment; and

FIG. 7 depicts processing system 700 in accordance with an embodiment.

### DETAILED DESCRIPTION

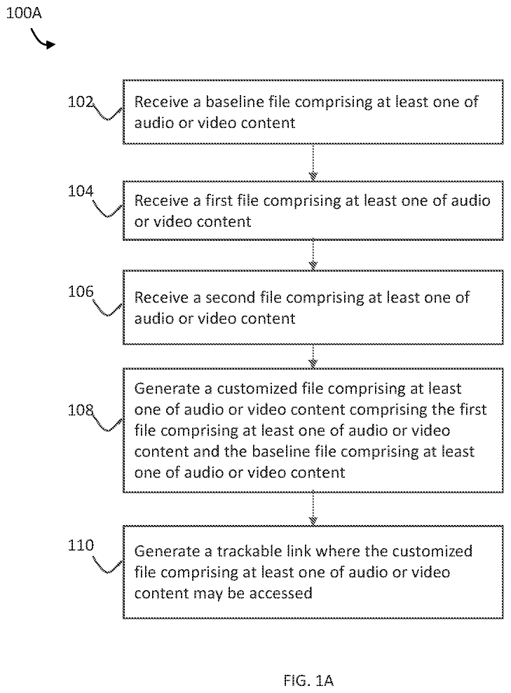

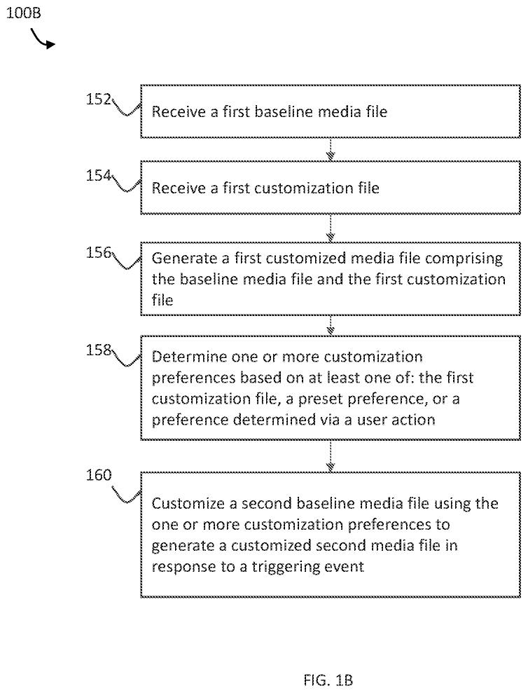

FIGS. 1A-7 and the following description depict specific examples to teach those skilled in the art how to make and use the best mode of the Application. For the purpose of teaching inventive principles, some conventional aspects have been simplified or omitted. Those skilled in the art will appreciate variations from these examples that fall within the scope of the Application. Those skilled in the art will appreciate that the features described below may be combined in various ways to form multiple variations of the Application. As a result, the Application is not limited to the specific examples described below, but only by the claims and their equivalents.

In the present Application, a method and system of automatically customizing a file comprising at least one of audio or video content and a method and system of automatically customizing a media file are described. The description references the problem of marketing within a channel partner-vendor business framework for context. This is not intended to be limiting, however. Those of skill will readily understand that the methods and systems described in the present Application may be applied to other contexts, such as, but not limited to: healthcare insurance marketplaces, sales enablement platforms, financial services, and car sales.

In the following description, references are made to a media creation user, a media deployment user, and an end consumer. In embodiments, the media creation user may be a vendor. The media creation user is one or more persons or entities that originate media content. In embodiments, the media content may comprise one or more media files (including any combination of video, audio, images, and text file content and formats). The media content may include marketing information directed to a service or a product, educational information, or may be directed towards entertainment.

The media deployment user is one or more persons or entities who receive the media content and customize the media content for their own use. In embodiments, the media deployment user may be a channel partner. In embodiments, the media deployment user may wish to add their own branding or information to the media content before distributing the customized media content via their own platforms.

The end consumer receives the customized media content provided via the media deployment user's platform or marketplace. In embodiments, the end customer may be shopping for a good or a service, and the customized media content may comprise information about goods and/or services that can be purchased from the media deployment user.

FIG. 1A depicts method 100A in accordance with an embodiment. Method 100A may be used to automatically customize a file comprising at least one of audio or video. In embodiments, the file comprising at least one of audio or video may include in any the formats from the following non-exclusive list: MPEG-1, MPEG-2, MPEG-4, AVI, MOV, AVCHD, H.264, H.265, DivX and DivX HD, Xvid HD, MKV, RMVB, WMV9, TS/TP/M2T, WMV, AAC, MP3, WAV, WMA, DOLBY DIGITAL, DTS. In further embodiments, however any file format for audio or video file may be used known to those of skill in the art.

Method 100A begins with step 102. In step 102, a baseline file comprising at least one of audio or video is received. The baseline file comprising at least one of audio or video may comprise, for example, a video, a podcast, a webcast, or any other format of audio and/or video known to those of skill. In embodiments, the baseline file comprising at least one of audio or video may be provided by a media creator and may be related to a product or service.

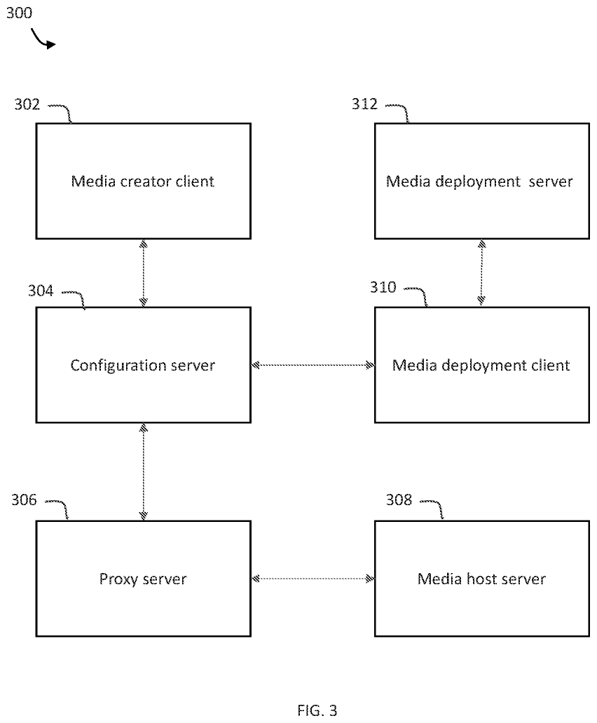

FIG. 3 depicts system 300, in accordance with an embodiment. System 300 is one example of a system that may be used to customize a file comprising at least one of audio or video. System 300 includes a media creation client 302 and a configuration server 304.

In step 102, media creation client 302 may be used to upload the baseline file comprising at least one of audio or video to configuration server 304. The configuration server 304 may receive and store the baseline file comprising at least one of audio or video from the media creation client 302. The configuration server 304 may then make the baseline file comprising at least one of audio or video available for a number of customizations by a media deployment user via a media deployment client 310.

Method 100A continues with step 104. In step 104, a first file comprising at least one of audio or video is received. In embodiments, the first file comprising at least one of audio or video may include a clip that may be used to customize the baseline file comprising at least one of audio or video, such as, for example, an introductory segment.

In embodiments, the media deployment user may provide the first file comprising at least one of audio or video. For example, in embodiments a media deployment user may use media deployment client 310 of system 300 to upload the first file comprising at least one of audio or video to configuration server 304 for storage.

Method 100A continues with step 108. In step 108, a customized file comprising at least one of audio or video comprising the first file comprising at least one of audio or video and the baseline file comprising at least one of audio or video is generated. In embodiments, the customized file comprising at least one of audio or video may comprise customized media content generated at the request of a media deployment user.

In embodiments, in system 300, configuration server 304 may retrieve the first file comprising at least one of audio or video and the baseline file comprising at least one of audio or video from a database (not depicted) and combine them into a new file, the customized file comprising at least one of audio or video, which may be subsequently stored in a database.

The customized file comprising at least one of audio or video may then be made available to a media deployment user via media deployment client 310 to publish via one or more marketplaces or platforms, such as, for example, a media deployment server 312. Advantageously, the customized file comprising at least one of audio or video may provide a co-branded product between the media creation user and the media deployment user without requiring the users to coordinate directly. The media deployment user may therefore receive timely, customized marketing content with minimal effort. Similarly, for the media creation user, the media content may have a higher chance of being utilized, promoting sales of a product or service on the media deployment user's platform.

In embodiments, method 100A may further comprise step 106. In step 106, a second file comprising at least one of audio or video may be received. In embodiments, the second file comprising at least one of audio or video may include a clip that may be used to customize the baseline file comprising at least one of audio or video, such as, for example, an outro segment.

In embodiments, the customized file comprising at least one of audio or video content may further comprise the second file comprising at least one of audio or video content, and the customized file comprising at least one of audio or video content may include the baseline file comprising at least one of audio or video content, the first file comprising at least one of audio or video content, and the second file comprising at least one of audio or video content in a predetermined order.

For example, the predetermined order may comprise using the first file comprising at least one of audio or video content as a first intro segment and the second file comprising at least one of audio or video as a third outro segment.

In embodiments, method 100A may further comprise step 110. In step 110, a trackable link may be generated where the customized file comprising at least one of audio or video content may be accessed. The trackable link may be used to access the customized file comprising at least one of audio or video content on a media host server.

The trackable link comprises a proxy server URL and a file ID. For example, the trackable link may comprise: www.channelsparkkit.com/share/d7Uvx7SE. In the example, the proxy server URL www.channelsparkkit.com identifies the proxy server and d7Uvx7SE is the file ID that specifically identifies the customized file comprising at least one of audio or video content.

For example, it may be seen in system 300 that configuration server 304 may communicate with a proxy server 306 to generate a trackable link. In embodiments, configuration server 304 may send the customized file comprising at least one of audio or video content to the proxy server 306 to request a trackable link. Proxy server 306 may then send the customized file comprising at least one of audio or video content to the media host server 308, where it may be stored and accessed. In further embodiments, however, configuration server 304 may send proxy server 306 a predetermined file location on media host server 308 where the customized file comprising at least one of audio or video content may be accessed. Proxy server 306 may then provide a trackable link to configuration server 304 to access the customized file comprising at least one of audio or video content.

Configuration server 304 may provide the trackable link to a media deployment user via a media deployment client 310. The media deployment user may integrate the trackable link into their own platform, such as, for example a website hosted on a media deployment server 312.

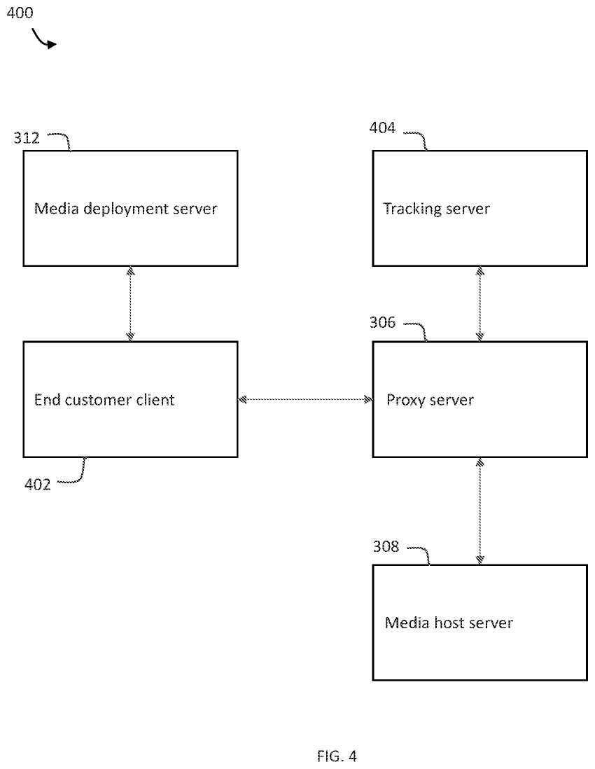

After the trackable link is integrated into a media deployment server 312, an end consumer may access the customized file comprising at least one of audio or video content via the trackable link. For example, FIG. 4 depicts system 400, which may be used to view media via media deployment server 312. System 400 includes an end customer client 402, the media deployment server 312, the proxy server 306, and the media host server 308. In embodiments, the end customer client 402 may comprise a web browser on a laptop, a smartphone, or a tablet. End customer client 402 may load a webpage retrieved from media deployment server 312 including the trackable link. When the end customer client 402 requests to view the customized file comprising at least one of audio or video content via the trackable link, the proxy server 306 requests the file from the media host server 308 and transmits it to the end customer client 402

Proxy server 306 facilitates tracking the number of times that the trackable link has been clicked by a user. In embodiments, proxy server 306 may track the number of times a trackable link has been accessed internally, or it may send notifications of events to an additional tracking server 404. Providing a trackable link through a proxy server 306 may allow the media creation user to track how many times the baseline file comprising at least one of audio or video content has been customized by the media deployment user, and to view those customizations. The trackable link may also allow the media creation user to determine how many times each customized file was accessed by an end consumer via one or more media deployment users. In embodiments, the trackable link may further allow the media deployment user to track how many times each customized file comprising at least one of audio or video content has been viewed as well.

In embodiments, the trackable link may further comprise one or more query parameters. For example, the trackable link may include one or more Urchin Tracking Module (UTM) parameters that facilitate further tracking via a service such as Google Analytics, as will be understood by those of skill.

In embodiments, steps 102-110 may be initiated by a media deployment user. In further embodiments, however, steps 102-110 may be initiated automatically by configuration server 304, as will be further described below.

FIG. 1B depicts method 100B, in accordance with an embodiment. Method 100B may be used to automatically customize a media file. In embodiments, the media file may comprise any combination of images, text, video, or audio known to those in the art.

Method 100B begins with step 152. In step 152, a first baseline media file is received. Step 152 is similar to step 102, except that it relates to a first baseline media file.

Method 100B continues with step 154. In step 154 a first customization file is received. Step 154 is similar to step 104, except that it relates to a first customization file. The first customization file may comprise any type of media file that may be used to customize the first baseline media file.

In embodiments, the first baseline media file and first customization file may comprise the same types of files, for example, video files. In further embodiments, however, the file first baseline media file and the first customization file may comprise different types of files. Any combination of first baseline media file and first customization file is contemplated by this Application.

Method 100B continues with step 156. In step 156, a first customized media file is generated comprising the baseline media file and the first customization file. In embodiments, this may be similar to step 108 described above for video and/or audio files. In further embodiments, however, step 156 may apply to a wider variety of media file types, such as those that comprise text and images.

Method 100B continues with step 158. In step 158, one or more customization preferences are determined based on at least one of: the first customization file, a preset preference, or a preference determined via a user action.

The one or more customization preferences may comprise, for example, a file format, a logo, an introduction splash for a video, an introduction song for a podcast, a phone number, a home website URL, or any other type of marketing, informational, or aesthetic customization that could be made to a media file known to those in of skill the art.

The preset preference may comprise a setting available for a media deployment user to select or set on the configuration server 304 via, for example, the media deployment client 310. For example, the media deployment user may set a customer service email address field on configuration server 304 via media deployment client 310.

The preference determined via a user action may comprise any preference determined automatically by configuration server 304 by the actions of a media deployment user. For example, configuration server 304 may determine that the media deployment user always uses the same logo when customizing media files, or videos that are shorter than three minutes in length. A preference determined via a user action may further comprise any other preference type for customizing media files known to those of skill. The preference determined via user action may be determined via a machine learning recommend system, a clustering algorithm, or via any technique known to those of skill.

Method 100B continues with step 160. In step 160, a second baseline media file is customized using the one or more customization preferences to generate a second customized media file in response to a triggering event. Step 160 is similar to step 156, except that it is initiated by the triggering event.

In embodiments, the triggering event may be a software status change detected via a state machine or interrupt routine. In embodiments, the triggering event may be one of: a preset timer expiration event or a newly received media file event.

In embodiments, the preset timer expiration event may be related to a timer expiring that was set for any reason relating to when a media deployment user may be ready to receive a new customized media file. For example, the timer may be set to represent the typical processing time for a media deployment user to manage a new customized media file.

In embodiments, a notification may be sent to the media deployment user informing about the availability of the second customized media file. The notification may be an email, an alert which may be viewed in the media deployment client, or any other type of notification known to those of skill.

In embodiments, method 100A may further comprise any combination of steps from method 100B, and vice-versa.

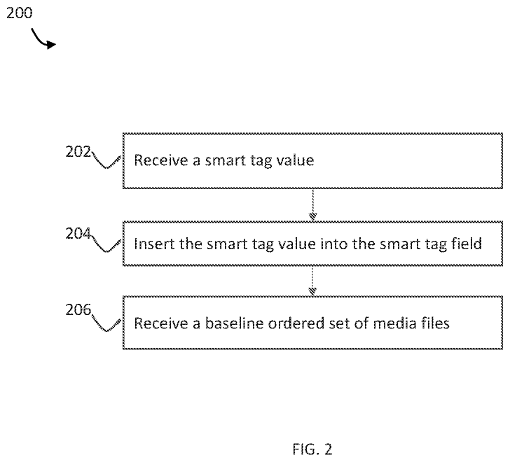

In embodiments, methods 100A or 100B may comprise any combination of steps of method 200, as depicted in FIG. 2.

Method 200 may include steps 202 and 204. In step 202, a smart tag value may be received. In step 204, the smart tag value may be inserted into the smart tag field. A smart tag field is a placeholder created by a media creator user in a media file that may be customized by a media deployment user. The smart tag field may be embedded in any video, audio, text, or image file. In embodiments, the smart tag field may comprise an image, a text field, or a third video or audio file. A media deployment user may set a smart tag value for a smart tag field, thereby customizing the media file.

In embodiments, the smart tag field may be embedded in any combination of the baseline file comprising at least one of audio or video content, the first baseline media file, or second baseline media file.

In embodiments, setting a smart tag value may simplify the customization required to co-brand a media file. In embodiments, setting the smart tag value may simplify the customization required to use a media file created by a media creation user to drive traffic back to a media deployment user's platform. Many other uses for a smart tag field are contemplated as well, as will be understood by those of skill.

In embodiments, method 200 may comprise step 206. In step 206, a baseline ordered set of media files may be received. A baseline ordered set of media files may comprise a series of media files that are configured to be viewed or consumed sequentially by an end consumer.

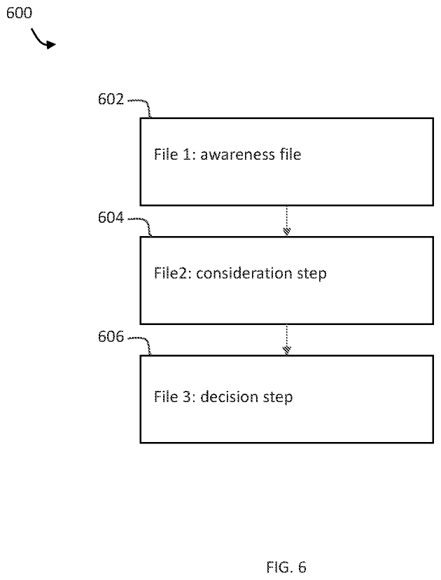

FIG. 6 depicts example baseline ordered set of media files 600, in accordance with an embodiment. The example baseline ordered set of media files 600 corresponds to different sequential steps of the demand generation process. For example, a first file 602 may correspond to an awareness step, a second file 604 may correspond to a consideration step, and a third file 606 may correspond to a decision step.

In embodiments, the ordered set of media files 600 may comprise the same type of media file or different types of media files. For example, the first file 602 may comprise a video file, the second file 604 may comprise a PDF file, and the third file 606 may comprise a podcast.

In embodiments, the media creation user may create and upload the baseline ordered set of media files 600 via media creator client 302 to configuration server 304, where they will be available to the media deployment user. In embodiments, the baseline ordered set of media files 600 may be customized by the media deployment user on configuration server 304 via media deployment client 310, or alternatively the ordered set of media files 600 may be customized automatically by the configuration server 304. The ordered set of media files 600 may then be used on media deployment server 312.

In embodiments, the first baseline media file and the second baseline media file may be members of a baseline ordered set of media files, the first baseline media file having a lower index number than the second baseline media file. Advantageously, this may allow, upon a media deployment user initiating the customization of the first baseline media file, for the second baseline media file to be customized automatically without user interaction. In embodiments, configuration server 304 may execute this second customization automatically in response to the triggering event.

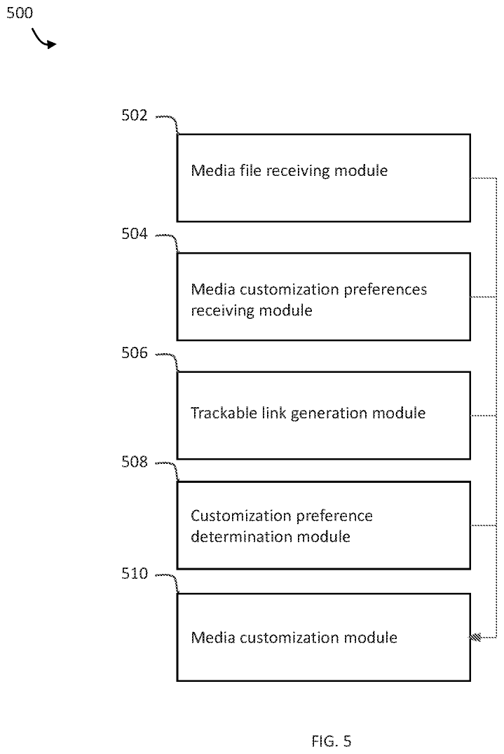

FIG. 5 depicts a system 500 in accordance with an embodiment. System 500 may be used to automatically customize a file comprising at least one of audio or video content or automatically customize a media file, according to any of the steps of methods 100A, 100B, and 200.

System 500 includes a media file receiving module 502, a media customizations preferences receiving module 504, and a media customization module 510. In embodiments, system 500 may further comprise a trackable link generation module 506 and a customization preference determination module 508. In embodiments, the modules of system 500 may be executed on any combination of configuration server 304, proxy server 306, and/or media host server 308, as described above.

In embodiments, the media file receiving module 502 is configured to execute any combination of steps 102 and/or 152, as described above.

In embodiments, the media customizations preferences receiving module 504 is configured to execute any combination of steps 104, 106, and/or 154, as described above.

In embodiments, the media customization module 510 is configured to execute any combination of steps 108, 156, and/or 160, as described above.

In embodiments, the trackable link generation module 506 is configured to execute step 110, as described above.

In embodiments, the customization preference determination module 508 is configured to execute step 158, as described above.

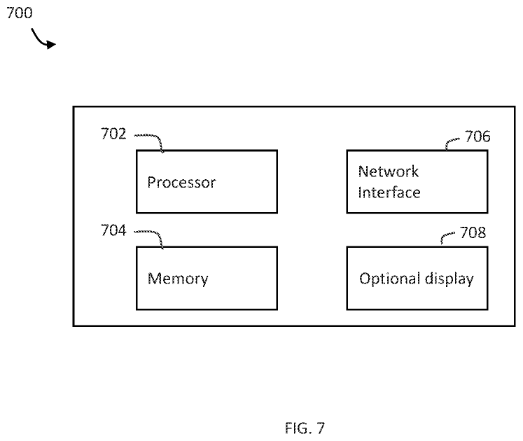

FIG. 7 depicts a processing device 700, in accordance with an embodiment. Each of the following entities of systems 300 and 400 include one or more instances of processing device 700: media creator client 302, configuration server 304, proxy server 306, media host server 308, media deployment client 310, media deployment server 312, end customer client 402, and tracking server 404.

Processing device 700 includes a processor 702, a memory 704, and a network interface 706. In examples, processing device 700 may further include an optional display 708.

Processor 702 may be configured to execute computer instructions which perform a portion or all of the methods described in relation to FIGS. 1A, 1B, and 2. In embodiments, processor 702 may include a single, or any multiple number of processors, as will be understood by those of skill in the art.

Memory 704 may be an electronically readable medium or a computer readable medium configured to store computer program instructions. In examples, memory 704 may include a non-transitory medium. Stored computer program instructions, when executed on the processor 702, may perform a portion or all of the methods described in relation to FIGS. 1A, 1B, and 2.

In examples, portions of the methods described in relation to FIGS. 1A, 1B, and 2 may be stored or executed outside of systems 300 or 400. For example, a portion of the methods described in relation to FIGS. 1A, 1B, and 2 may be stored or executed on a combination of a server and cloud storage facility via the Internet.

Network interface 706 may be configured to communicate with devices external to processing device 700. In examples, network interface 706 may include wired or wireless interfaces. Network interface 706 may include WIFI, 3G, 4G, Ethernet, or any other communications known to those of skill in the art.

The methods and systems of this Application may provide the ability for both a media creation user and a media deployment user to optimize their utilization of media to promote products and services on a marketplace or platform with effective marketing together.

The detailed descriptions of the above examples are not exhaustive descriptions of all examples contemplated by the inventors to be within the scope of the Application. Indeed, persons skilled in the art will recognize that certain elements of the above-described examples may variously be combined or eliminated to create further examples, and such further examples fall within the scope and teachings of the Application. It will also be apparent to those of ordinary skill in the art that the above-described examples may be combined in whole or in part to create additional examples within the scope and teachings of the Application. Accordingly, the scope of the Application should be determined from the following claims.

What is claimed is:

1. A method of automatically customizing a file comprising at least one of audio or video content, the method comprising:
receiving a baseline file comprising at least one of audio or video content;
receiving a first file comprising at least one of audio or video content; and
generating a customized file comprising at least one of audio or video content comprising the first file comprising at least one of audio or video content and the baseline file comprising at least one of audio or video content.

2. A method of automatically customizing files comprising at least one of audio or video content as claimed in claim 1, further comprising:
receiving a second file comprising at least one of audio or video content; and
wherein the customized file comprising at least one of audio or video content further comprises the second file comprising at least one of audio or video content, and the customized file comprising at least one of audio or video content includes the baseline file comprising at least one of audio or video content, the first file comprising at least one of audio or video content, and the second file comprising at least one of audio or video content in a predetermined order.

3. A method of automatically customizing files comprising at least one of audio or video content as claimed in claim 1, wherein at least one of the first file comprising at least one of audio or video content or the baseline file comprising at least one of audio or video content comprises a smart tag field, and the method further comprises:
receiving a smart tag value; and
inserting the smart tag value into the smart tag field in at least one of the first file comprising at least one of audio or video content or the baseline file comprising at least one of audio or video content.

4. A method of automatically customizing files comprising at least one of audio or video content as claimed in claim 1, wherein the smart tag field is an image, a text field, or a third file comprising at least one of audio or video content.

5. A method of automatically customizing files comprising at least one of audio or video content as claimed in claim 1, further comprising:
generating a trackable link where the customized file comprising at least one of audio or video content may be accessed comprising a proxy server URL and a file ID.

6. A method of automatically customizing files comprising at least one of audio or video content as claimed in claim 5, wherein the trackable link further comprises one or more query parameters.

7. A method of automatically customizing a media file, the method comprising:
receiving a first baseline media file;
receiving a first customization file;
generating a first customized media file comprising the baseline media file and the first customization file;
determining one or more customization preferences based on at least one of: the first customization file, a preset preference, or a preference determined via a user action; and
customizing a second baseline media file using the one or more customization preferences to generate a customized second media file in response to a triggering event.

8. A method of automatically customizing a media file as claimed in claim 7, wherein the triggering event is one of: a preset timer expiration event or a newly received media file event.

9. A method of automatically customizing a media file as claimed in claim 7, wherein the method further comprises:
receiving a baseline ordered set of media files,
and wherein the first baseline media file and the second baseline media file are members of the ordered set of media files, the first baseline media file having a lower index number than the second baseline media file.

10. A method of automatically customizing a media file as claimed in claim 7, wherein at least one of the first baseline media file or the first customization file further comprise a smart tag field, and the method further comprises:
receiving a smart tag value; and
inserting the smart tag value into the smart tag field in the at least one of the first baseline media file or the first customization file.

11. A method of automatically customizing a media file as claimed in claim 10, wherein the smart tag field comprises an image, a text field, or a third file comprising at least one of audio or video content.

12. A system for automatically customizing a file comprising at least one of audio or video content, the system comprising:
a media file receiving module configured to receive a baseline file comprising at least one of audio or video content;
a media customizations preferences receiving module configured to receive a first file comprising at least one of audio or video content; and
a media customization module configured to generate a customized file comprising at least one of audio or video content comprising the first file comprising at least one of audio or video content and the baseline file comprising at least one of audio or video content.

13. A system for automatically customizing files comprising at least one of audio or video content as claimed in claim 12, wherein the media file receiving module is further configured to receive a second file comprising at least one of audio or video content, and the media customization module is further configured to include the second file comprising at least one of audio or video content in the customized file comprising at least one of audio or video content, the customized file comprising at least one of audio or video content including the baseline file comprising at least one of audio or video content, the first file comprising at least one of audio or video content, and the second file comprising at least one of audio or video content in a predetermined order.

14. A system for automatically customizing files comprising at least one of audio or video content as claimed in claim 12, wherein at least one of the first file comprising at least one of audio or video content or the baseline file comprising at least one of audio or video content comprises a smart tag field, the media customizations preferences receiving module is further configured to receive a smart tag value, and the media customization module is further configured to insert the smart tag value into the smart tag field in at least one of the first file comprising at least one of audio or video content or the baseline file comprising at least one of audio or video content, the smart tag field comprising an image, a text field, or a third file comprising at least one of audio or video content.

15. A system for automatically customizing files comprising at least one of audio or video content as claimed in claim 12, further comprising:
a trackable link generation module configured to generate a trackable link where the customized file comprising at least one of audio or video content may be accessed, the trackable link comprising a proxy server URL and a file ID.

16. A system for automatically customizing files comprising at least one of audio or video content as claimed in claim 13, wherein the trackable link further comprises one or more query parameters.

17. A system for automatically customizing media files, the system comprising:
a media file receiving module configured to receive a first baseline media file;
a media customization preferences receiving module configured to receive a customization file;
a media customization module configured to generate a first customized media file comprising the baseline media file and the first customization file; and
a customization preferences determination module configured to determine one or more customization preferences based on at least one of: the first customization file, a preset preference, or a preference determined via a user action;
and wherein the media customization module is further configured to customize a second baseline media file using the one or more customization preferences to generate a customized second media file in response to a triggering event.

18. A system for automatically customizing media files as claimed in claim 17, wherein the triggering event is one of: a preset timer expiration event or a newly received media file event.

19. A system for automatically customizing media files as claimed in claim 17, wherein the media file receiving module is further configured to receive a baseline ordered set of media files, and the first baseline media file and the second baseline media file are members of the ordered set of media files, the first baseline media file having a lower index number than the second baseline media file.

20. A system for automatically customizing media files as claimed in claim 17, wherein at least one of the first baseline media file or the first customization file further comprise a smart tag field, and the system further comprises:
a media customization preferences receiving module configure to receive a smart tag value, and
wherein the media customization module 510 is further configured to insert the smart tag value into the smart tag field in the at least one of the first baseline media file or the first customization file, wherein the smart tag field comprises an image, a text field, or a third file comprising at least one of audio or video content.
